(19) United States
(12) Patent Application Publication
(10) Pub. No.: US 2011/0145180 A1
(43) Pub. Date: Jun. 16, 2011

(54) Diagnostic Method for a Process Automation System

(75) Inventor: Alexander Muller, Sasbach-Jechtingen (DE)

(73) Assignee: Endress + Hauser GmbH + Co., KG, Maulburg (DE)

(21) Appl. No.: 13/058,050

(22) PCT Filed: Jul. 2, 2009
(86) PCT No.: PCT/EP2009/058301

§ 371 Date: Feb. 8, 2011

(30) Foreign Application Priority Data
Aug. 8, 2008 (DE) 10 2008 036 968.3

(51) Int. Cl. G06N 3/08

(52) U.S. Cl. 706/23; 706/25

(57) ABSTRACT

A diagnostic method for a process automation system composed of at least one field device, a control unit, and at least one fieldbus. The following method steps are included: in a learning phase raw data of measured variables, raw data of manipulated variables and/or raw data of state variables are stored. The field devices or the processes as input variables are registered and stored normalized. Moreover, in the learning phase at least one parameter, a measuring condition, at least one parameter of a process state and/or at least one parameter of a field device state as output variable predetermines, which corresponding output variables are the input variables associated with that which is stored, during the learning phase. A neural network formed by the input variables and the associated with output variables, in the learning phase are the causal relationships between the ascertained input variables and the corresponding, specified output variables by a transfer function of the neural network ascertained and stored, in an operating phase is by means of the transfer function from the current raw data the field devices as input variables at least one change of the current measuring condition, the current process state and/or the current field device state ascertained.

The invention relates to a diagnostic method for a process automation system composed of at least one field device, a control unit, and at least one fieldbus, as defined in the preamble of claim 1.

In industrial measurements technology, especially in automation- and process control technology, field devices are regularly applied, which, in the course of a process, ascertain, by means of sensors, process variables or adjust, by means of actuators, manipulated variables.

Such field devices include e.g. flow-, fill level-, pressure- or pressure difference-, and temperature measuring devices, as well as actuators. These are, as a rule, arranged decentrally in the immediate vicinity of the process component to be measured or controlled, and deliver a measurement signal, which corresponds to the measured value of the registered process variable. The measurement signals of the field devices are forwarded to a superordinated unit, e.g. a central control unit, such as e.g. a control room or a process control system. As a rule, the entire process control occurs via the superordinated unit, which receives and evaluates the measurement signals of the individual measuring devices and, as a function of the evaluation, produces control signals for the actuators, which control the process flow. In this way, example, flow through a pipeline section can be set by means of a controllable valve as a function of measured flow.

A faultless and frictionless working of the field devices is of great importance for the safety of the applications, in which they are applied. Correspondingly, the functional ability of field devices is exactly monitored and occurring errors are displayed, e.g. in the form a warning or an alarm, by corresponding error reports. Preferably, the monitoring is done by the field device itself, wherein the field device performs a self monitoring and/or diagnosis. For this, field devices today are, in part, equipped with means for performing diagnostic methods. These are able, based on input variables available in the field device, to diagnose the occurrence of certain errors or states of the field device. For this, the input variables are analyzed based on evaluating methods fixedly implemented in the field device and the occurrence of monitoring criteria characteristic for the error or the state is monitored. If such a monitoring criterion occurs, the field device issues the associated diagnostic value.

Such a diagnostic method in a field device is described, for example, in U.S. Pat. No. 5,419,197 A. In such case, a sensor-containing measuring system, e.g. an acceleration sensor, is applied for the diagnosis of a machine. The measured variable of the acceleration sensor is fed, together with the diagnostic state of the machine, to a neural network, which determines the transfer function of the diagnostic system (learning process). The acceleration sensor is applied only for the purpose of analysis of the machine diagnosis with a neural network.

Furthermore, such diagnostic systems are disclosed in US 2002077711. In such case, the process diagnosis, among other things, is implemented by application of the existing sensor data. These ascertained sensor data are processed by means of selectable mathematical functions and the results of the processing are taken into consideration within an evaluation system for the additional diagnosis of the process. In this diagnostic system, predefined functions are used for analysis of the sensor data. To create these functions requires a high measure of knowledge concerning the process and the type and functioning of the diagnostic method.

In the patent LP 1 364 263 A1, very extensively, data both from process sensors as well as also service data from maintenance- and service departments concerning the sensors and the entire process installation are collected. The collection of the data of the decentrally distributed sensor system can, in such case, occur via the fieldbus system. The analysis of the data of the individual sensors occurs via diagnostic functions in predetermines function blocks the sensor programs.

Another instance of the state of the art, wherein a neural network finds application, is U.S. Pat. No. 5,311,562. In this diagnostic system, the measured values already ascertained and preprocessed by sensors, i.e. operational parameters, are used for the diagnosis of the process or the state of the sensors.

The state of the art has the following disadvantages, which are overcome by the invention:
To this point in time, separate sensor systems have been used for diagnosis and for ascertaining process values or for tuning manipulated variables.
Previous diagnostic solutions require a very high measure of knowledge concerning the process and the diagnostic method as regards the chain from causes to effects. In order, in this case, to be able to perform a diagnosis safely, the cause/effect chain of the process must be known and manageable.
The previous diagnostic systems use not sensor raw data, but, instead, processed and filtered, measured values or even averages of measured values. In this way, a process-near analysis and diagnosis is made almost impossible, since the process information or the information on the sensor states needed for safe diagnosis are already filtered out by the signal processing in the sensors.

Today's diagnostic methods are predetermined in the field device at the factory and are limited, as a rule, to the detecting of field device specific errors or states. There are, however, a very large number of errors or states, which are application-specific and are either not even registered by the field device or cannot be sufficiently exactly analyzed, evaluated and/or interpreted by the field device with today's diagnostic options.

A reason for this is that manufacturers of field devices do not, as a rule, have prior knowledge concerning where and how the field device will be applied. Correspondingly, the manufacturer also does not know, which error or states are relevant for the user at the location of use in the process, and what meaning should be attributed in the current process to these errors and states.

It is an object of the invention to provide a diagnostic method for a field device, that diagnoses a broad spectrum of possible errors and/or states and does not degrade the availability of the field device.

This object is achieved according to the invention by a diagnostic method for a process automation system comprising at least one field device, a control unit, and at least one fieldbus, which includes method steps as follows: In a learning phase, raw data of measured variables, raw data of manipulated variables and/or raw data of state variables of the field devices or the processes are registered as input variables and stored normalized, moreover, in the learning phase, the user specifies at least one parameter of a measuring condition, at least one parameter of a process state and/or at least one parameter of a, field device state as output variable, corresponding output variables are stored associated with input variables, during the learning phase, the input variables and the associated output variables are fed to a neural network, in the learning phase, causal relationships between the ascertained input variables and the corresponding, specified output variables are ascertained by a transfer function of the neural network and stored, and, in an operating phase, by means of the transfer function, from current raw data of the field devices as input variables, at least one change of a current measuring condition, a current process state and/or a current field device state is ascertained.

An advantageous form of embodiment of the method of the invention provides that the diagnostic method is performed automatically in the field devices and results of the diagnosis are transmitted to the control unit and/or other field devices.

Another advantageous form of embodiment of the solution of the invention provides that the diagnostic method is performed in the control unit by transmitting the raw data of the field devices via the fieldbus and transmitting parameters likewise via the fieldbus or inputting directly at an input/output unit of the control unit.

A very advantageous variant of the method of the invention provides that the neural network stores the causal relationships between the ascertained input variables and the corresponding, specified output variables in the form of at least one transfer function.

An especially advantageous further development of the method of the invention provides that periodic registering of the raw data as input variables and periodic specification of the parameters as output variables are performed simultaneously in the learning phase.

A preferred form of embodiment of the method of the invention provides that the parameters are quantified by the user by gradual estimating of field device state, process state and/or measuring condition.

In an advantageous form of embodiment of the method of the invention, it is provided that the parameters of the output variables are specified by the user in a range of 1 to 10.

A effective example of an embodiment of the method of the invention provides that limit values of the parameters are specified, by means of which validity of the input variables, a critical measuring condition, a critical field device state and/or a critical process state is established.

A effective, alternative example of an embodiment of the method of the invention provides that the raw data of measured variables, manipulated variables and/or state variables of the different field devices of the same process are classified.

In a preferred form of embodiment of the method of the invention, it is provided that, based on a comparison of the change in the classified raw data of measured variables, manipulated variables and/or state variables of the field devices, a cause and/or a measure for the change of the current measuring condition, the current process state and/or the current field device state are/is ascertained.

A preferred form of embodiment of the method of the invention provides that specification of the parameters by the user is performed by a menu guided input via an in/output unit.

An advantageous form of embodiment of the solution of the invention provides that the learning phase is performed at start-up of the field device and/or the process.

The invention and other advantages will now be explained in greater detail based on the figures of the drawing, in which an example of an embodiment is presented; equal elements are provided in the figures with equal reference characters. The figures of the drawing show as follows:

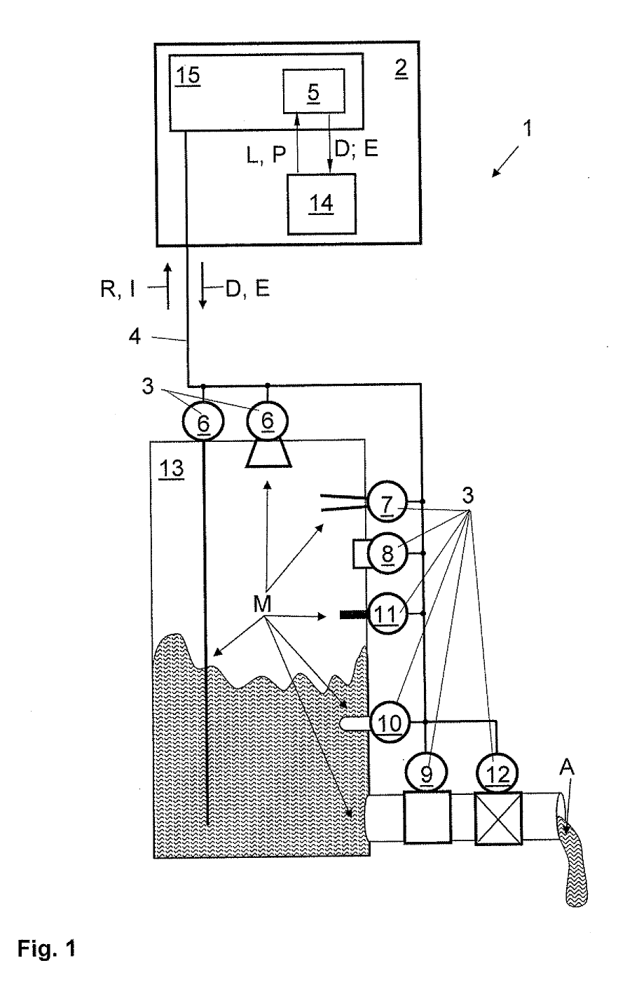

FIG. 1 a block diagram of a process with field device for performing the diagnostic method defined by the user; and

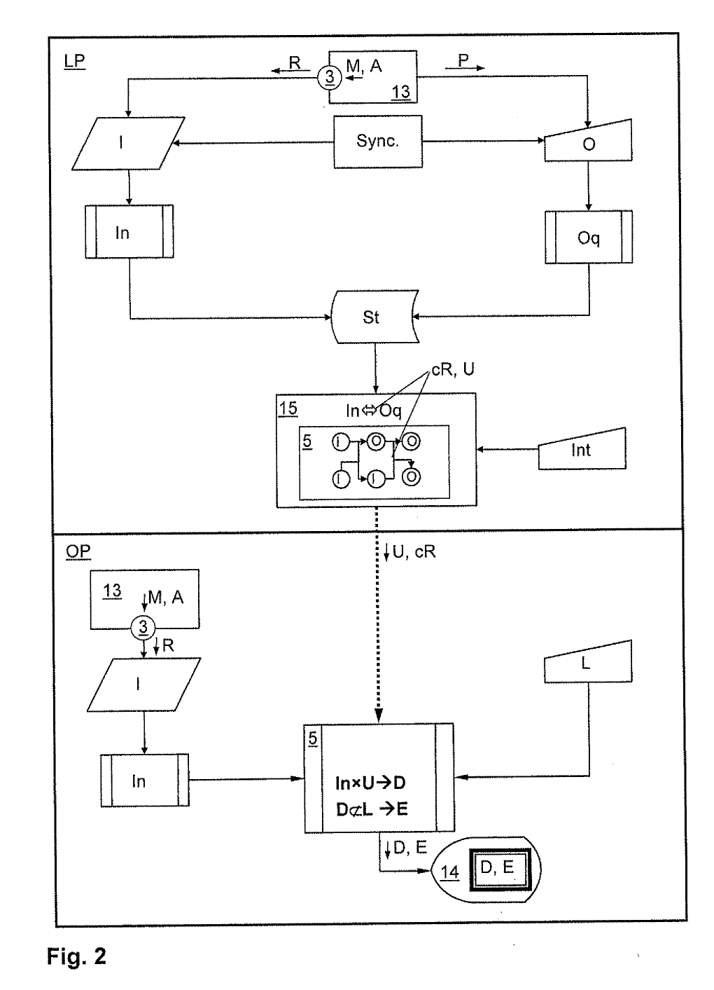

FIG. 2 a flow diagram of the diagnostic method of the invention.

FIG. 1 shows a simplified block diagram of a process automation system 1 of the invention composed of a control unit, or control station, 2 and a plurality of field devices 3 at a container of the first process 13. The individual field devices 3 communicate with one another and with the control unit 2 via a fieldbus 4 and/or a two-wire connecting line. Integrated in the control unit 2 is a control/evaluation unit 15, which performs control of the automated process, evaluation, analysis and/or diagnosis of measured values M or actuating values A of the individual field devices 3. A process variable V is a physical variable, which occurs exclusively in the case of state changes S in processes 13. The measured values M and actuating values A are values of these process variables V or of their state variables S of the process 13 and are ascertained from the sensors or actuators of the field devices 3.

Mounted in the process 13 in FIG. 1 are, for example, two fill level measuring devices 6, a limit-level measuring device 7, a pressure measuring device 8, a temperature measuring device 11 and an analytical measuring device 10. Mounted on the outlet nozzle of the container are a flow measuring device 9 and an actuator 12 integrated with a valve, which ascertain and/or set transport of the fill substance away from the container through the outlet. Field devices 3 communicate with one another and/or with the control unit 2, for example, via a digital fieldbus 4, such as e.g. a Profibus PA or a Fieldbus. Analogously to the hardwired communication via a digital fieldbus 4, communication can also occur via a corresponding wireless communication unit (not shown in FIG. 1), according to one of the known standards, such as e.g. ZigBee, WLAN, or Bluetooth.

Control unit 2 includes at least one control/evaluation unit 15, which is connected with the field devices 3 via the fieldbus 4 or the two-wire-connecting line 4 and requests and receives the raw data R as input variable I for the diagnostic function. Furthermore, via the same fieldbus 4, the measured values M of the sensors of the field devices 3 are received by the control unit 2 and the manipulated variables S sent to the actuators of the field devices 3 in the process 13. Associated with control/evaluation unit 15 is an input/output unit 14, via which the diagnostic value D and/or the ascertained error state B is displayed and parameters P of the process 13 and/or of the field devices 3, as well as limit values L for the diagnostic values D can be input, or specified. In the control unit 2, moreover, a memory unit St is provided, which enables storage of the transfer function U of the neural network 5, the raw data R of the field devices 3, the limit values L, the parameters P, diagnostic values D and error states E. For calculating the complex transfer function U of the neural network 5, a powerful microprocessor is provided in control unit 2.

The raw data R of the field devices 3 are sent as input variables I via the fieldbus 4 upon request or cyclically to the control/evaluation unit 15 in the control station 2. In the neural network 5 contained in the control/evaluation unit 15, the input variables I are used in a learning phase LP to construct the transfer functions U of the neural network. The diagnostic values D and error states E ascertained in the operating phase OP in the neural network 5 are transmitted via the fieldbus 4 or a wireless radio connection to the field devices 3 or an alarm state is output to the input/output unit 14 of the control station 2 or to an input/output unit (not shown) of a field device 3.

FIG. 2 shows a flow diagram of the diagnostic method of the invention involving a neural network 5. The diagnostic method can be divided basically into two method phases: A learning phase LP, in which the transfer functions U are ascertained in the neural network 5 from the raw data R of the field devices 3 as an input variable I and the parameters P of the process states PS and the field device states FDS as an output variable A; and an operating phase OP, in which the trained transfer functions U of the neural network 5, based on the raw data of the field devices 3 as input variables I and predetermined limit values L, performs a diagnosis of the process state PS and/or of the field device state FDS. Input of the parameters P requires of the operator a certain functional knowledge, concerning how the processes 13 run and how the field devices 3 function.

In the learning phase LP of the transfer functions U of the neural network 5 for the diagnosis of process states PS and field device states FDS in a process 13 after start-up of a field device 3 and/or of a new process 13, raw data R of manipulated variables S and/or measured variables M of the field devices 3 are registered in the control station 2 as input variables I of the control/evaluation unit 15. Synchronously therewith, an operator of the process plants registers the parameters P of the process states PS and the field device states FDS and feeds them via an output/input unit 14 into the control/evaluation unit 15 as output variables O. The raw data R as input variables I are normalized, for example, by filtering and/or by data compression to a normalized input variable In and the parameters P are qualified by a checking routine, as well as converted by a quantifying routines into a measurable numerical value as quantified output variable Oq. The quantified output variable Oq and the normalized input variable In are stored in a memory unit. From the stored values of the quantified output variable Oq and the normalized input variable In, the control/evaluation unit 15 in the control station 2 ascertains, upon an input command for the initializing Int of the learning process LP, the transfer functions U of the neural network 5. These ascertained transfer functions U of the neural network 5 are stored in the memory unit.

In the operating phase OP of the process automation system 1, these ascertained transfer functions U of the neural network 5 are loaded. The raw data R of the field devices 3 registered in the operating phase OP of the process automation system I are registered as input variables I and, as earlier in the learning phase LP, converted into normalized input variables In. The neural network 5 ascertains from the current, normalized input variables In by means of the transfer function U a diagnostic value D as output variable O. This diagnostic value D is compared with a predetermined limit value L, or it is checked, for example, whether the ascertained diagnostic value lies within a range between minimum and maximum limit values L. If the diagnostic value D lies outside the specifications of the limit values L, then an error state E of the process automation system 1 is produced by the control/evaluation unit 15. This error state E can be presented by the control/evaluation unit 15 on the input/output unit 14 as an alarm. At the same time, for example, by an acoustic signal, the alarm of the error state E signals to the control station 2 or to the field device 3.

The diagnostic method of the invention for monitoring a process automation system 1 includes basically the following method steps:
In a learning phase LP, the raw data R of measured variables M, raw data R of manipulated variables S and/or raw data R of state variables S of the field devices 3 or of the processes 13 are registered as input variables I and stored as normalized input variables In,
at the same time, in the learning phase LP, the user, or operator, as the case may be, specifies parameters P of a measuring condition and process situation as a parameter P of a process state PS and/or at least one parameter P of a field device state FDS as output variable O,
the corresponding output variables O are quantified, i.e. there are assigned to determined output variables O determined, measurable values, and the quantified output variables O are stored in association with corresponding, normalized input variables In,
during the learning phase LP, normalized input variables I and associated output variables O are fed to a neural network 5,
in the learning phase LP, from causal relationships cR between ascertained input variables I and the corresponding, specified output variables O, a transfer function U of the neural network 5 is ascertained and stored,
in an operating phase OP, by means of the stored transfer function U, from current raw data R of the field devices 3 as input variables O at least one change of current measuring condition, current process state and/or current field device state is ascertained.

Now, an example of an embodiment of the invention will be presented. The example of an embodiment poses the problem that, due to accretion of a liquid on the sensors of the field devices 3, a periodic cleaning of the process measurements equipment is required, in order that on-going validity of the measured values M of e.g. pressure, temperature, fill level, flow, pH-value and limit-level can be assured. On the basis of experience, such cleaning should be performed every 4 weeks in the process 13. During such cleaning procedures, it can be noticed that the sensors of the field devices 3 are sometimes scarcely and other times, very strongly, fouled. Validity of the measured values M is sometimes already no longer present and, at other times, the cleaning was much too soon. A diagnostic system for predictive maintenance is needed here.

For solution of this problem of process automation technology, the invention can contribute. During the introduction of a processes 13, the so-called “golden batch”, cyclically, e.g. hourly or daily, accretion formation on the sensors of the field devices is judged and fed in the form of parameter P to the neural network 5 as output variable O. This parameter P is stored in a database, or memory unit, with a scale of 1—clean-to 10—very strongly fouled. As limit value L for the validity of the measured values M, for example, a parameter P of the degree of fouling of 7 is specified. In the same cycle, e.g. hourly or daily, the raw data R (e.g. the envelope curve of a Levelflex radar level transmitter and the spectrum of a Liquiphant level limit switch) of the field devices 3 are recorded as input variable I. These input variables I are normalized as earlier described. After terminating the process introduction, the data sets of the parameter P of the degree of fouling are fed in the form of quantified output variable Oq and the raw data R in the form of normalized input variables In to a neural network 5, which ascertains the corresponding transfer function U therefrom.

This transfer function U can now be used with the limit value L as diagnostic function in this process application. A stronger fouling than the limit value G of the parameter P leads to the invalidity of the measuring. To be noted is, in such case, that the transfer function U of the degree of fouling of the sensors of the field devices 3 can be used only for this process validity in this process 13. A transfer to other processes 13 is not possible, exactly as the transfer of the causes/effect chain to other processes 13 is not possible.

The invention shows that this reference of cause and effect need not be earlier known. The cause effect relationship is first ascertained in the learning process and is unique for the special case of diagnosis of a process.

### LIST OF REFERENCE CHARACTERS

1 process automation system
2 control unit, control station
3 field device
4 fieldbus, two-wire-connecting line
5 neural network
6 fill-level measuring device
7 limit-level measuring device
8 pressure measuring device
9 flow measuring device
10 analytical measuring device
11 temperature measuring device
12 actuator
13 process
14 input/output unit
15 control/evaluation unit
D diagnostic value
E error state
FDS field device state
PS process state
P parameter
O output variable
I input variable
U transfer function
M measured variable, measured value
A manipulated variable, actuating value
S state variables
R raw data
LP learning phase
OP operating phase
L limit value
St storage
Int initializing

1-12. (canceled)

13. A diagnostic method for a process automation system comprising at least one field device, a control unit, and at least one fieldbus, the method comprising the steps of:
in a learning phase, raw data of measured variables, raw data of manipulated variables and/or raw data of state variables of the field devices or the processes are registered as input variables and stored normalized;
in the learning phase, moreover a user specifies at least one parameter of a measuring condition, at least one parameter of a process state and/or at least one parameter of a field device state as an output variable;
corresponding output variables are stored associated with input variables,
during the learning phase, the input variables and the associated output variables are fed to a neural network;
in the learning phase, causal relationships between the ascertained input variables and the corresponding, specified output variables are ascertained by a transfer function of the neural network and stored; and,
in an operating phase, by means of the transfer function, from current raw data of the field devices as input variables, at least one change of a current measuring condition, a current process state and/or a current field device state is ascertained.

14. The diagnostic method as claimed in claim 13, wherein:
the diagnostic method is performed automatically in the field devices and results of diagnosis are transmitted to the control unit and/or other field devices.

15. The diagnostic method as claimed in claim 13, wherein:
the diagnostic method is performed in the control unit by transmitting raw data of the field devices via the fieldbus and by transmitting parameters likewise via the fieldbus or by inputting parameters directly at an input/output unit of the control unit.

16. The diagnostic method as claimed in claim 13, wherein:
the neural network stores causal relationships between ascertained input variables and corresponding, specified output variables in at least one transfer function.

17. The diagnostic method as claimed in claim 13, wherein:
in the learning phase, periodic registering of raw data as input variables and periodic specification of parameters as output variables are performed simultaneously.

18. The diagnostic method as claimed in claim 13, wherein:
the parameters are quantified by the user by gradual estimation of field device state, process state and/or measuring condition.

19. The diagnostic method as claimed in claim 18, wherein:
the parameters of the output variables are specified by the user in a range of 1 to 10.

20. The diagnostic method as claimed in claim 13, wherein:
limit values of the parameters are specified, by means of which validity of input variables, a critical measuring condition, a critical field device state and/or a critical process state is established.

21. The diagnostic method as claimed in claim 13, wherein:
the raw data of measured variables, of manipulated variables and/or of state variables of the different field devices of the same process are classified.

22. The diagnostic method as claimed in claim 21, wherein:
based on a comparison of change in classified raw data of measured variables, manipulated variables and/or of state variables of the field devices, a cause and/or a measure for the change of a current measuring condition, a current process state and/or a current field device state is ascertained.

23. The diagnostic method as claimed in claim 13, wherein:
the specification of the parameters by the user is performed by menu guided input via an in/output unit.

24. The diagnostic method as claimed in claim 13, wherein:
the learning phase is performed at start-up of the field device and/or the process.
